(19) United States
(12) Patent Application Publication
(10) Pub. No.: US 2024/0169623 A1
(43) Pub. Date: May 23, 2024

(54) MULTI-MODAL IMAGE GENERATION

(71) Applicant: ADOBE INC., SAN JOSE, CA (US)

(72) Inventors: Yu Zeng, Baltimore, MD (US); Zhe Lin, Clyde Hill, WA (US); Jianming Zhang, Fremont, CA (US); Qing Liu, Santa Clara, CA (US); Jason Wen Yong Kuen, Santa Clara, CA (US); John Philip Collomosse, Surrey (GB)

(21) Appl. No.: 18/057,857

(22) Filed: Nov. 22, 2022

(51) Int. Cl. G06T 11/60; G06F 40/295; G06T 7/11; G06V 10/774; G06V 10/776

(52) U.S. Cl. CPC G06T 11/60; G06F 40/295; G06T 7/11; G06V 10/774; G06V 10/776; G06T 2200/24; G06T 2207/20081; G06T 2207/20084

(57) ABSTRACT

Systems and methods for multi-modal image generation are provided. One or more aspects of the systems and methods includes obtaining a text prompt and layout information indicating a target location for an element of the text prompt within an image to be generated and computing a text feature map including a plurality of values corresponding to the element of the text prompt at pixel locations corresponding to the target location. Then the image is generated based on the text feature map using a diffusion model. The generated image includes the element of the text prompt at the target location.

### BACKGROUND

The following relates generally to machine learning, and more specifically to machine learning for image generation. Machine learning is an information processing field in which algorithms or models such as artificial neural networks are trained to make predictive outputs in response to input data without being specifically programmed to do so. For example, a machine learning model can be used to generate an image based on input data, where the image is a prediction of what the machine learning model thinks the input data describes.

Machine learning techniques can be used to generate images according to multiple modalities. Diffusion models are a category of machine learning model that generates data based on stochastic processes. Specifically, diffusion models introduce random noise at multiple levels and train a network to remove the noise. Once trained, a diffusion model can start with random noise and generate data similar to the training data.

### SUMMARY

Aspects of the present disclosure provide systems and methods for multi-modal image generation. According to an aspect of the present disclosure, an image generation system obtains a text input identifying an element to be included in an image, and also obtains an area of the image that is to depict the element. In some cases, the multi-modal image generation system receives the area as external input. In other cases, the multi-modal image generation predicts the area based on the text input.

According to an aspect of the present disclosure, the multi-modal image generation system computes a multi-dimensional array including dimensions of the image and a vector representation of the element input based on the text input and the area. According to an aspect of the present disclosure, the multi-modal image generation system generates the image based on the multi-dimensional array using a diffusion model. By generating the image based on the multi-dimensional array using a diffusion model, the multi-modal image generation system is able to obtain an image that depicts the element at an accurate location while using a sparsely described area for the element, thereby reducing a processing time for generating the image.

A method, apparatus, non-transitory computer readable medium, and system for multi-modal image generation are described. One or more aspects of the method, apparatus, non-transitory computer readable medium, and system include obtaining a text prompt and layout information indicating a target location for an element of the text prompt, wherein the target location is within an image to be generated; computing a text feature map including a plurality of values corresponding to the element of the text prompt at pixel locations corresponding to the target location; and generating an image based on the text feature map using a diffusion model, wherein the image includes the element of the text prompt at the target location.

A method, apparatus, non-transitory computer readable medium, and system for multi-modal image generation are described. One or more aspects of the method, apparatus, non-transitory computer readable medium, and system include identifying a training image, a text prompt, and layout information indicating a location of an element of the text prompt in the training image; computing a text feature map including a plurality of values corresponding to the element of the text prompt at a position corresponding to the location of the element; generating a predicted image based on the text feature map using a diffusion model; comparing the predicted image to the training image; and training the diffusion model by updating parameters of the diffusion model based on the comparison.

An apparatus and system for multi-modal image generation are described. One or more aspects of the apparatus and system include one or more processors; one or more memory components coupled with the one or more processors; a preliminary diffusion model configured to generate a text feature map including a plurality of values corresponding to an element of a text prompt at a position corresponding to a target location; and a diffusion model configured to generate a predicted image based on the text feature map, wherein the predicted image includes the element of the text prompt at the target location.

### BRIEF DESCRIPTION OF THE DRAWINGS

FIG. 1 shows an example of an image generation system according to aspects of the present disclosure.

FIG. 2 shows an example of a method for multi-modal image generation according to aspects of the present disclosure.

FIG. 3 shows an example of an image generation apparatus according to aspects of the present disclosure.

FIG. 4 shows an example of a guided diffusion architecture according to aspects of the present disclosure.

FIG. 5 shows an example of a U-Net architecture according to aspects of the present disclosure.

FIG. 6 shows an example of a U-Net block according to aspects of the present disclosure.

FIG. 7 shows an example of a method for image generation according to aspects of the present disclosure.

FIG. 8 shows an example of semantic image synthesis according to aspects of the present disclosure.

FIG. 9 shows an example of text-to-image generation using named entity recognition according to aspects of the present disclosure.

FIG. 10 shows an example of user-guided text-to-image generation using named entity recognition according to aspects of the present disclosure.

FIG. 11 shows an example of multi-modal image editing according to aspects of the present disclosure.

FIG. 12 shows an example of image generation using a hybrid brush according to aspects of the present disclosure.

FIG. 13 shows an example of diffusion processes according to aspects of the present disclosure.

FIG. 14 shows an example of a method for updating parameters of a diffusion model according to aspects of the present disclosure.

FIG. 15 shows an example of a method for training a preliminary diffusion model according to aspects of the present disclosure.

FIG. 16 shows an example of a method for training an untrained diffusion model according to aspects of the present disclosure.

FIG. 17 shows an example of a computing device according to aspects of the present disclosure.

### DETAILED DESCRIPTION

Embodiments of the present disclosure relate generally to machine learning, and more specifically to machine learning for image generation. Machine learning techniques can be used to generate images according to multiple modalities. For example, a machine learning model can be trained to generate an image based on a text input or an image input, such that the content of the generated image is determined based on information included in the text input or the image input.

However, conventional machine learning models rely on a generative adversarial network (GAN) or transformer-based neural network to produce an image based on input text. Both the GAN and transformer-based approaches to image generation rely on dense location information, where each pixel of an image to be generated is mapped to an image element described by the input text, to produce an image that approximates the intended result. This results in a great deal of effort on the part of a user if a user provides the pixel mapping, or a slow processing time if the machine learning model provides the mapping.

There is therefore a need in the art for multi-modal image generation systems and methods that can generate an accurate and realistic image based on a text input that uses a less demanding pixel mapping technique to generate the image. According to an aspect of the present disclosure, a multi-modal image generation system obtains a text input identifying an element to be included in an image, and also obtains an area of the image that is to depict the element. In some cases, the multi-modal image generation system receives the area as input from a user. In other cases, the multi-modal image generation system identifies the area based on the text input.

According to an aspect of the present disclosure, the multi-modal image generation system computes a multi-dimensional array including dimensions of the image and a vector representation of the element input based on the text input and the area. According to an aspect of the present disclosure, the multi-modal image generation system generates the image based on the multi-dimensional array using a diffusion model. By generating the image based on the multi-dimensional array using a diffusion model, the multi-modal image generation system is able to obtain an image that depicts the element at an accurate location while using a sparsely described area for the element, thereby reducing a processing time for generating the image.

An example of the present disclosure is used in an image generation context. In the example, a user wants to create an image that depicts specific elements at specific locations. The user provides a text input for each element to a user interface of the multi-modal image generation system, and also paints corresponding areas of a blank canvas displayed in the user interface to indicate where each of the elements should be displayed. The user does not have to paint an area for each element, and the user does not have to paint an area for each pixel of the image. In other words, the painted areas can be “sparse”. Based on the text inputs and the corresponding painted areas, the multi-modal image generation system computes a text feature map (i.e., the multi-dimensional array) and generates the image depicting the elements in locations corresponding to the respective painted areas.

In another example, the user provides an unstructured sentence as the text input. The multi-modal generation system extracts potential elements from the unstructured sentence, and the user can select one or more of the potential elements as an element. In some cases, rather than painting areas of a blank canvas to indicate where in the image the one or more elements should be positioned, the multi-modal image generation system predicts locations for the elements based on the text input using another diffusion model.

In some cases, these predicted locations are also “sparse” (e.g., they do not have to correspond to each pixel of the image to be generated). In some cases, the user can adjust the locations to better fit an intended image that the user has in mind. The multi-modal image generation system then computes the text feature map based on the selected element(s) and their respective locations, and the diffusion model generates the image based on the text feature map. In some cases, the diffusion model combines the text feature map with a global embedding of the original unstructured sentence input so that unselected elements and other style information included in the unstructured sentence are incorporated in the generated image.

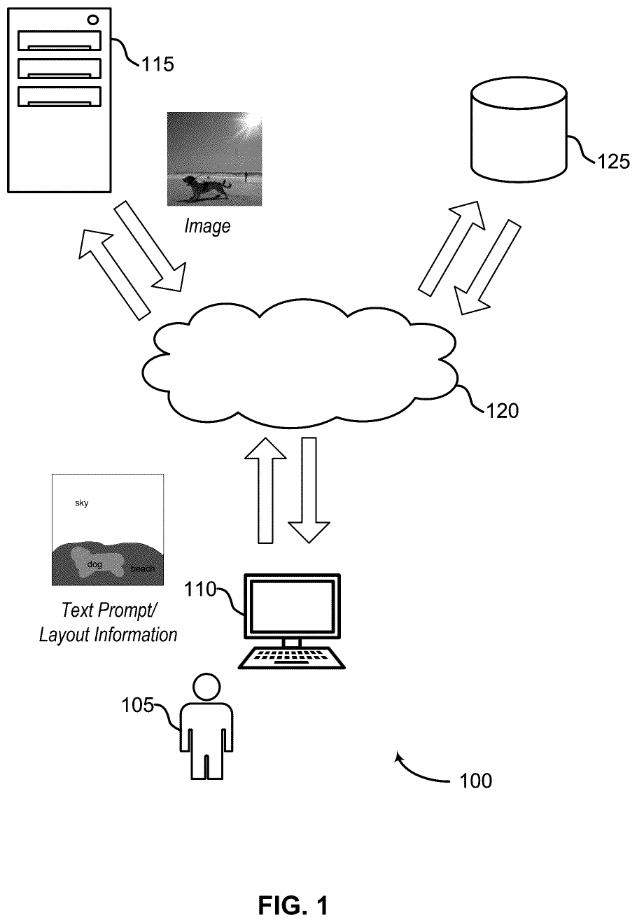

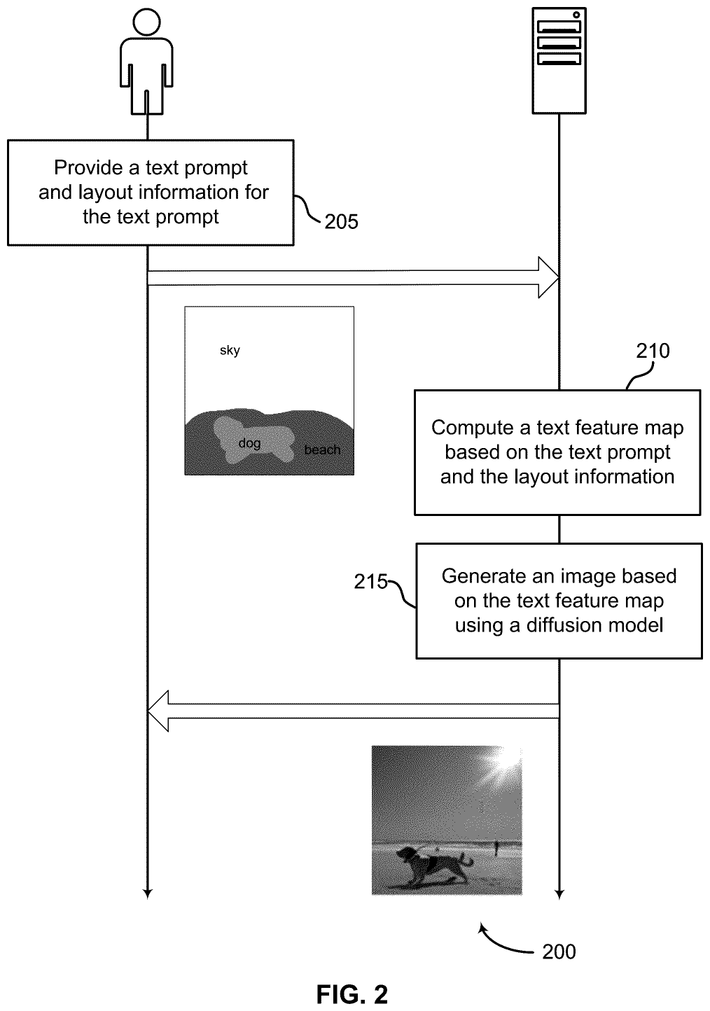

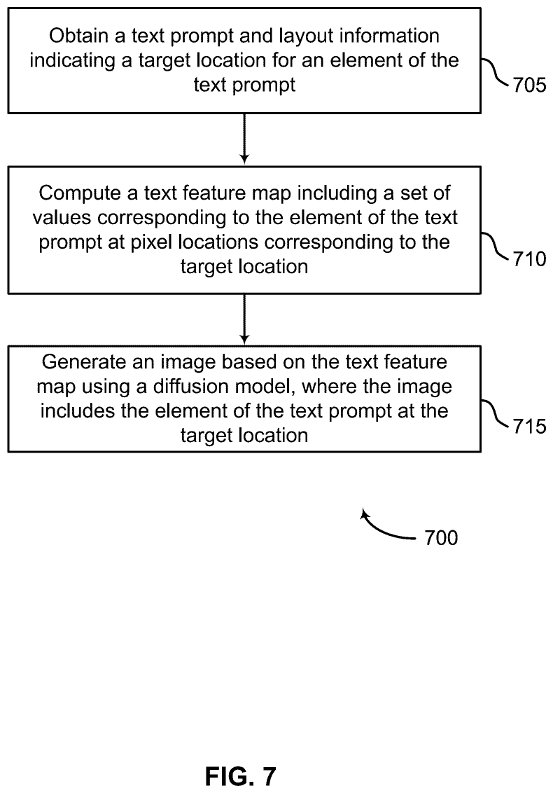

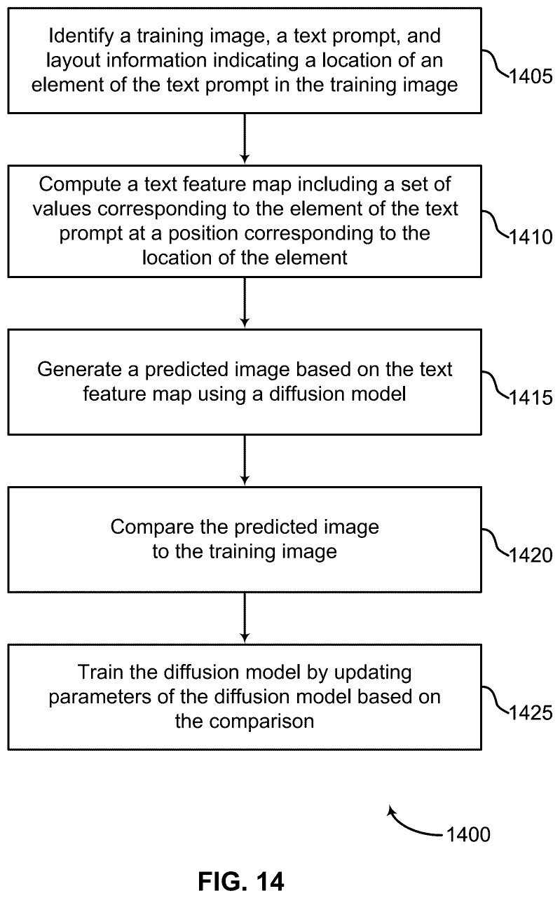

Further example applications of the present disclosure in the image generation context are provided with reference to FIGS. 1-2. Details regarding the architecture of the multi-modal image generation system are provided with reference to FIGS. 1-6 and 17. Examples of a process for multi-modal image generation are provided with reference to FIGS. 7-13. Examples of a process for training a machine learning model are provided with reference to FIGS. 14-16.

Accordingly, embodiments improve the speed and accuracy of image generation systems by providing image features to a diffusion model that indicate regions of an image to include various objects or elements. As a result, users can automatically create a variety of different images that are consistent with a desired layout. The layout information can be provided using one or more modalities including direct layout guidance (e.g., marking regions of an image with a brush tool), text guidance describing the layout, or an image depicting the desired layout. This provides users flexibility that can reduce the time and effort necessary to generate a target output compared to traditional image generation systems.

### Multi-Modal Image Generation System

A system and an apparatus for multi-modal image generation is described with reference to FIGS. 1-6 and 17. One or more aspects of the system and the apparatus include one or more processors; one or more memory components coupled with the one or more processors; a first diffusion model configured to generate a text feature map including a plurality of values corresponding to an element of a text prompt at a position corresponding to a target location; and a second diffusion model configured to generate a predicted image based on the text feature map, wherein the predicted image includes the element of the text prompt at the target location.

Some examples of the system and the apparatus further include a training component configured to compare the predicted image to a training image, and to update parameters of the second diffusion model based on the comparison. Some examples of the system and the apparatus further include a named entity recognition (NER) component configured to identify a plurality of entities in the text prompt including the element.

Some examples of the system and the apparatus further include an encoder configured to encode the text prompt to obtain a text prompt embedding representing global information of the text prompt. Some examples of the system and the apparatus further include a user interface configured to identify the text prompt and layout information indicating the target location for the element of the text prompt.

In some aspects, the second diffusion model comprises a pixel diffusion model. In some aspects, the first diffusion model or the second diffusion model comprises a U-Net architecture.

FIG. 1 shows an example of an image generation system 100 according to aspects of the present disclosure. The example shown includes user device 110, image generation apparatus 115, cloud 120, and database 125.

Referring to FIG. 1, user 105 provides a text prompt to image generation apparatus 115 via a user interface displayed by image generation apparatus 115 on user device 110. In some cases, the text prompt corresponds to a single element to be included in an image, and the user identifies the element via the user interface. In some cases, the text prompt is an unstructured sentence including one or more elements to be added to the image. In some cases, image generation apparatus 115 extracts named entities from the unstructured sentence, and user 105 identifies one or more elements corresponding to the extracted named entities via the user interface. In the example of FIG. 1, user 105 identifies three elements (“sky”, “dog”, and “beach”) to be added to the image.

In some cases, user 105 provides layout information for the element to image generation apparatus 115. For example, user 105 can use a brush tool of the user interface to paint an area of a blank canvas or a preexisting image to identify a target location of the image to which the element should be added, where the layout information comprises the target location. In the example of FIG. 1, user 105 respectively paints an area of a blank canvas for each of the three elements sky, dog, and beach, where each of the painted areas respectively corresponds to a target location for the three elements in the image. In some cases, user 105 only provides the text prompt, and image generation apparatus 115 generates the layout information based on the text prompt.

In some cases, image generation apparatus 115 computes a text feature map for the image based on the text prompt and the layout information. In some cases, the text feature map comprises a multi-dimensional array including a first dimension corresponding to an image width, a second dimension corresponding to an image height, and a third dimension corresponding to an element.

In some cases, image generation apparatus 115 generates an image based on the text feature map using a diffusion model. In the example of FIG. 1, the image respectively depicts a dog, a beach, and a sky at locations determined by user 105 according to the layout information. In some cases, the user can provide further input to the image using the brush tool and/or an additional text prompt to generate a subsequent image. For example, a user can provide a text prompt “sand dune”, paint an area of the generated image that should depict the sand dune, and image generation apparatus 115 generates the subsequent image to include the original image as a background and a sand dune superimposed over the background at the specified location.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image generation apparatus 115. In some aspects, the user interface allows user 105 to provide a text prompt and/or layout information to image generation apparatus 115. In some aspects, the user interface allows user 105 to provide an image for editing to image generation apparatus 115. In some aspects, image generation apparatus 115 provides the image to user 105 via the user interface.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

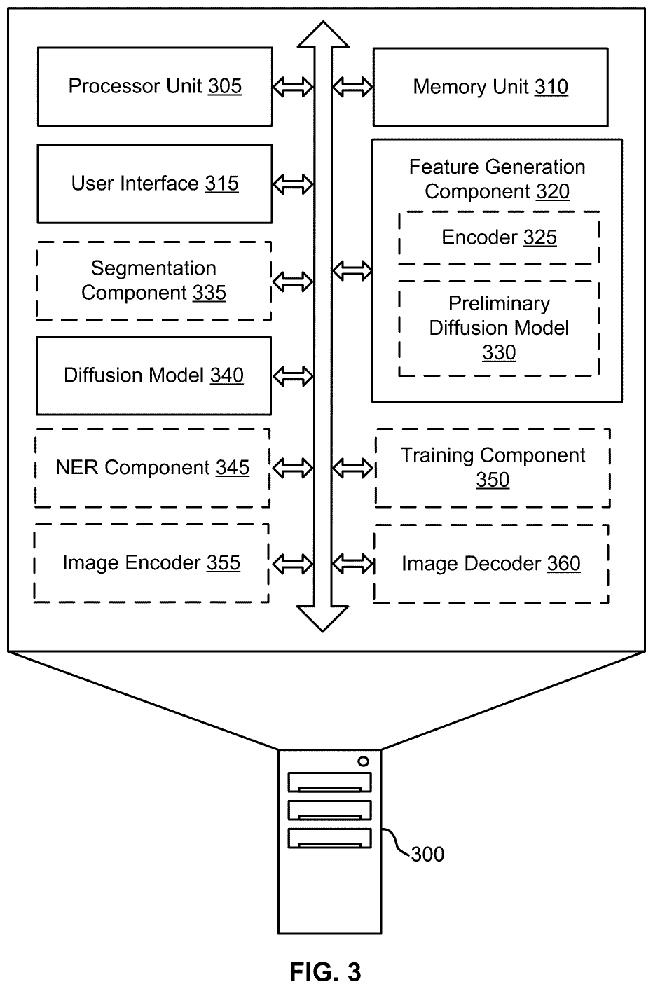

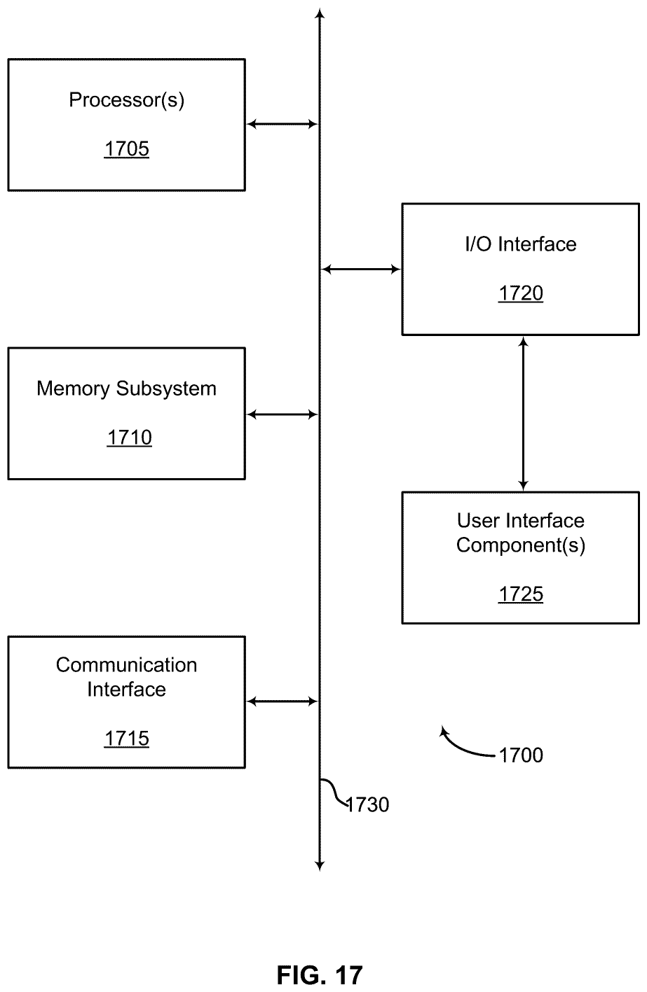

According to some aspects, image generation apparatus 115 includes a computer implemented network. In some embodiments, the computer implemented network includes a machine learning model (such as a diffusion model as described with reference to FIG. 3). In some embodiments, image generation apparatus 115 also includes one or more processors, a memory subsystem, a communication interface, an I/O interface, one or more user interface components, and a bus as described with reference to FIG. 17. Additionally, in some embodiments, image generation apparatus 115 communicates with user device 110 and database 125 via cloud 120.

In some cases, image generation apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Image generation apparatus 115 is an example of, or includes aspects of, the corresponding element described with reference to FIG. 3. Further detail regarding the architecture of image generation apparatus 115 is provided with reference to FIGS. 2-6 and 17. Further detail regarding a process for image generation is provided with reference to FIGS. 7-13. Further detail regarding a process for training a machine learning model of image generation apparatus 115 is provided with reference to FIGS. 14-16.

Cloud 120 is a computer network configured to provide on-demand availability of computer system resources, such as data storage and computing power. In some examples, cloud 120 provides resources without active management by user 105. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image generation apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image generation apparatus 115 and communicates with image generation apparatus 115 via cloud 120. According to some aspects, database 125 is included in image generation apparatus 115.

FIG. 2 shows an example of a method 200 a method for multi-modal image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, the system generates an image based on a text prompt and layout information. In some cases, a user provides the text prompt to a user interface of the system. In some cases, the user provides the layout information via the user interface. In some cases, the system predicts the layout information based on the text prompt. In some cases, the system generates the image using a diffusion model based on a text feature map, where the text feature map is computed based on the text prompt and the location information. By generating the image based on the text feature map, the diffusion model is able to obtain an image with an accurate positioning of elements depicted in the image using sparse layout information.

At operation 205, a user as described with reference to FIG. 1 provides a text prompt and layout information for the text prompt. For example, referring to FIG. 2, the user provides three text prompts “sky”, “dog”, and “beach”, each corresponding to an element to be included in an image, to a user interface of the system as described with reference to FIG. 7. The user also provides layout information by providing a brush input for each of the three text prompts to the user interface as described with reference to FIG. 7, where the brush input indicates a label map for a target location of each element in the image.

At operation 210, the system computes a text feature map based on the text prompt and the layout information. In some cases, the operations of this step refer to, or may be performed by, an image generation apparatus as described with reference to FIGS. 1 and 3. For example, the image generation apparatus computes the text feature map as described with reference to FIG. 7.

At operation 215, the system generates an image based on the text feature map using a diffusion model. In some cases, the operations of this step refer to, or may be performed by, an image generation apparatus as described with reference to FIGS. 1 and 3. For example, the image generation apparatus generates the image using the diffusion model as described with reference to FIG. 7. In some cases, the image generation apparatus displays the image to the user via the user interface.

FIG. 3 shows an example of an image generation apparatus 300 according to aspects of the present disclosure. Image generation apparatus 300 is an example of, or includes aspects of, the corresponding element described with reference to FIG. 1. In one aspect, image generation apparatus 300 includes processor unit 305, memory unit 310, user interface 315, feature generation component 320, segmentation component 335, diffusion model 340, named entity recognition (NER) component 345, training component 350, image encoder 355, and image decoder 360.

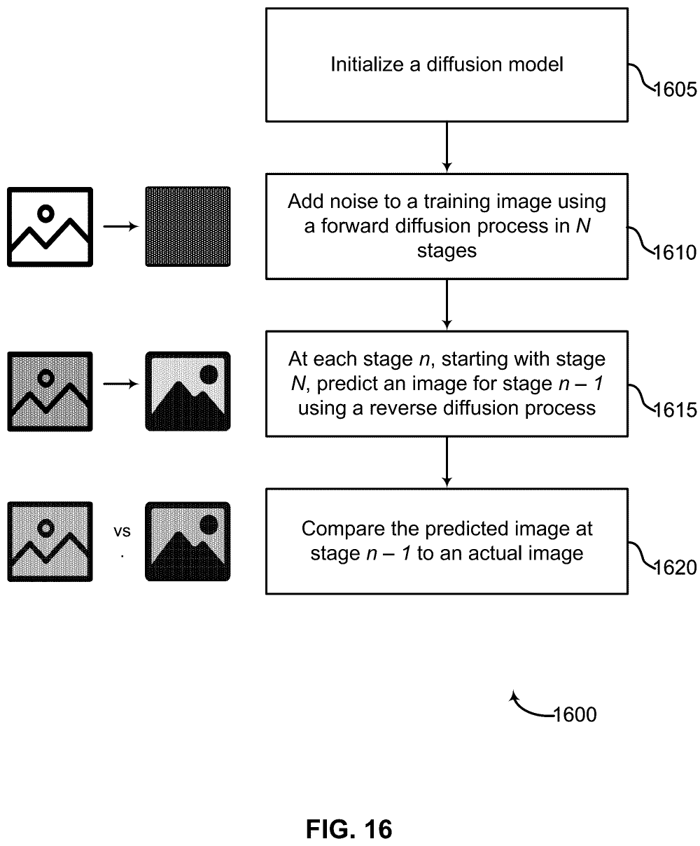

Image generation apparatus 300 is an example of, or includes aspects of, the computing device described with reference to FIG. 16. For example, in some cases, feature generation component 320, segmentation component 335, diffusion model 340, NER component 345, training component 350, image encoder 355, image decoder 360, or a combination thereof are implemented as hardware circuits that interact with components similar to the ones illustrated in FIG. 17 via a channel. For example, in some cases, user interface 315, feature generation component 320, segmentation component 335, diffusion model 340, NER component 345, training component 350, image encoder 355, image decoder 360, or a combination thereof are implemented as software stored in a memory subsystem described with reference to FIG. 17.

Processor unit 305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 305 is configured to operate a memory array using a memory controller. In other cases, a memory controller is integrated into processor unit 305. In some cases, processor unit 305 is configured to execute computer-readable instructions stored in memory unit 310 to perform various functions. In some aspects, processor unit 305 includes special purpose components for modem processing, baseband processing, digital signal processing, or transmission processing. According to some aspects, processor unit 305 comprises the one or more processors described with reference to FIG. 17.

Memory unit 310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 305 to perform various functions described herein. In some cases, memory unit 310 includes a basic input/output system (BIOS) that controls basic hardware or software operations, such as an interaction with peripheral components or devices. In some cases, memory unit 310 includes a memory controller that operates memory cells of memory unit 310. For example, the memory controller may include a row decoder, column decoder, or both. In some cases, memory cells within memory unit 310 store information in the form of a logical state. According to some aspects, memory unit 310 comprises the memory subsystem described with reference to FIG. 17.

According to some aspects, user interface 315 displays preliminary layout information based on a segmentation mask. In some examples, user interface 315 receives user input indicating a target location for an element of a text prompt in response to the displaying the preliminary layout information.

According to some aspects, user interface 315 is configured to identify a text prompt and layout information indicating a target location for an element of the text prompt. According to some aspects, user interface 315 is implemented as software stored in memory unit 310 and executable by processor unit 305.

According to some aspects, feature generation component 320 obtains the text prompt and the layout information indicating a target location for an element of the text prompt. In some examples, feature generation component 320 computes a text feature map including a set of values corresponding to the element of the text prompt at pixel locations corresponding to the target location.

In some aspects, the layout information includes a label map or a segmentation mask, where the target location includes a region of the label map or the segmentation mask. In some aspects, the text feature map includes a multi-dimensional array including a first dimension corresponding to an image width, a second dimension corresponding to an image height, and a third dimension corresponding to an entity embedding.

According to some aspects, feature generation component 320 comprises one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In one aspect, feature generation component 320 includes encoder 325 and preliminary diffusion model 330. According to some aspects, encoder 325 encodes the text prompt to obtain a text prompt embedding representing global information of the text prompt, where the image is generated based on the text prompt embedding. In some examples, encoder 325 encodes each of the set of entities to obtain a set of entity embeddings, where the text feature map includes values from the set of entity embeddings at positions corresponding to the set of entities, respectively.

According to some aspects, encoder 325 is configured to encode the text prompt to obtain a text prompt embedding representing global information of the text prompt. According to some aspects, encoder 325 comprises one or more ANNs. For example, in some cases, encoder 325 comprises a transformer, a Word2vec Model, or a Contrastive Language-Image Pre-training (CLIP) model.

A transformer or transformer network is a type of ANN used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word.

In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence), and V are the values, which are again the vector representations of all the words in the sequence. For the encoder and decoder, multi-head attention modules, V consists of the same word sequence than Q. However, for the attention module that takes into account the encoder and the decoder sequences, V is different from the sequence represented by Q. In some cases, values in V are multiplied and summed with some attention weights.

A Word2vec model may comprise a two-layer ANN trained to reconstruct the context of terms in a document. A Word2vec model takes a corpus of documents as input and produces a vector space as output. The resulting vector space may comprise hundreds of dimensions, with each term in the corpus assigned a corresponding vector in the space. The distance between the vectors may be compared by taking the cosine between two vectors. Word vectors that share a common context in the corpus will be located close to each other in the vector space.

A CLIP model is an ANN that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The model can then output a linear classifier of CLIP's visual representations.

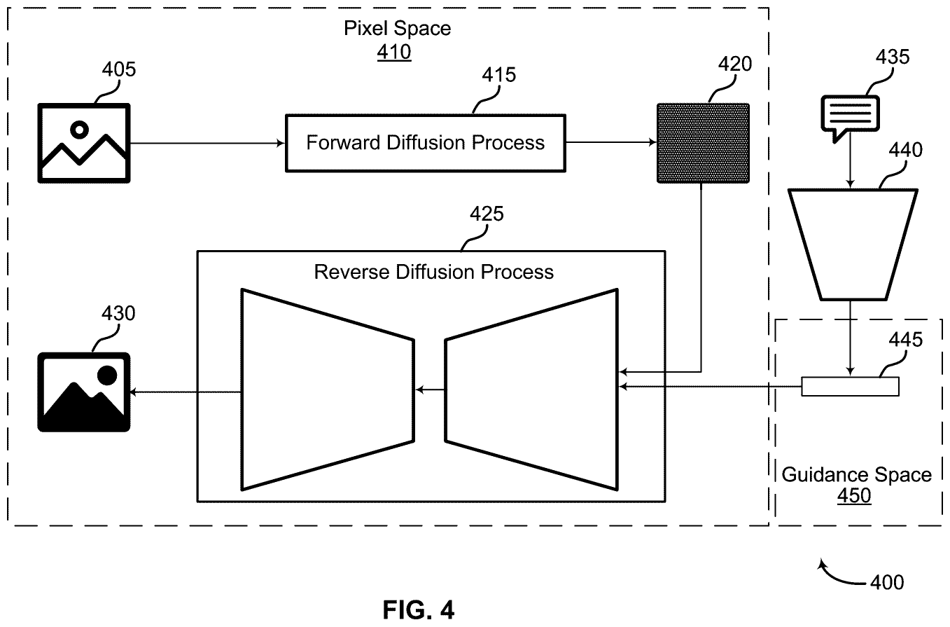

According to some aspects, encoder 325 is implemented as software stored in memory unit 310 and executable by processor unit 305, as firmware, as one or more hardware circuits, or as a combination thereof. In some embodiments, encoder 325 is an example of, or includes aspects of, the text encoder described with reference to FIG. 4. According to some aspects, encoder 325 is omitted from image generation apparatus 300. According to some aspects, encoder 325 is included in image generation apparatus 300 as a separate component from feature generation component 320.

According to some aspects, preliminary diffusion model 330 generates a preliminary image based on the text prompt. According to some aspects, preliminary diffusion model 330 generates predicted layout information using a preliminary diffusion model 330.

According to some aspects, preliminary diffusion model 330 is configured to generate a text feature map including a plurality of values corresponding to an element of a text prompt at a position corresponding to a target location. According to some aspects, preliminary diffusion model 330 comprises one or more ANNs. In some aspects, preliminary diffusion model 330 comprises a pixel diffusion model. In some aspects, preliminary diffusion model 330 comprises a latent diffusion model. In some aspects, preliminary diffusion model 330 comprises a U-Net. According to some aspects, preliminary diffusion model 330 is implemented as software stored in memory unit 310 and executable by processor unit 305, as firmware, as one or more hardware circuits, or as a combination thereof. In some embodiments, preliminary diffusion model 330 is an example of, or includes aspects of, the diffusion model described with reference to FIG. 4. According to some aspects, preliminary diffusion model is omitted from image generation apparatus 300.

According to some aspects, feature generation component 320 is implemented as software stored in memory unit 310 and executable by processor unit 305, as firmware, as one or more hardware circuits, or as a combination thereof.

According to some aspects, segmentation component 335 segments the preliminary image to obtain a segmentation mask, where the layout information is based on the segmentation mask. According to some aspects, segmentation component 335 comprises one or more ANNs. For example, in some cases, segmentation component 335 comprises a Mask-R-CNN, a U-Net, or another ANN architecture configured to segment an image to obtain a segmentation mask.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

A standard CNN may not be suitable when the length of the output layer is variable, i.e., when the number of the objects of interest is not fixed. Selecting a large number of regions to analyze using conventional CNN techniques may result in computational inefficiencies. Thus, in an R-CNN approach, a finite number of proposed regions are selected and analyzed.

A Mask R-CNN is a deep ANN that incorporates concepts of the R-CNN. Given an image as input, the Mask R-CNN provides object bounding boxes, classes, and masks (i.e., sets of pixels corresponding to object shapes). A Mask R-CNN operates in two stages, by generating potential regions (i.e., bounding boxes) where an object might be found and then identifying the class of the object, refining the bounding box, and generating a pixel-level mask in pixel level of the object. These stages may be connected using a backbone structure such as a feature pyramid network (FPN).

According to some aspects, segmentation component 335 is implemented as software stored in memory unit 310 and executable by processor unit 305, as firmware, as one or more hardware circuits, or as a combination thereof. According to some aspects, segmentation component 335 is omitted from image generation apparatus 300.

According to some aspects, diffusion model 340 generates an image based on the text feature map, where the image includes the element of the text prompt at the target location. In some examples, diffusion model 340 identifies a noise image including random noise, where the image is generated based on the noise image. In some examples, diffusion model 340 generates intermediate features. In some examples, diffusion model 340 combines the intermediate features with the text feature map to obtain combined features, where the image is generated based on the combined features. In some examples, diffusion model 340 combines the intermediate features with the text prompt embedding to obtain preliminary combined features, where the combined features are based on the preliminary combined features.

According to some aspects, diffusion model 340 includes one or more artificial neural networks (ANNs). In some aspects, diffusion model 340 comprises a pixel diffusion model. In some aspects, diffusion model 340 comprises a latent diffusion model. In some aspects, diffusion model 340 comprises a U-Net. According to some aspects, diffusion model 340 is implemented as software stored in memory unit 310 and executable by processor unit 305, as firmware, as one or more hardware circuits, or as a combination thereof. In some embodiments, diffusion model 340 is an example of, or includes aspects of, the corresponding element described with reference to FIG. 4.

According to some aspects, NER component 345 identifies a set of entities in the text prompt including the element. According to some aspects, the NER component comprises an ANN architecture including one or more ANNs configured to perform a named entity recognition process. According to some aspects, NER component 345 is implemented as software stored in memory unit 310 and executable by processor unit 305, as firmware, as one or more hardware circuits, or as a combination thereof. According to some aspects, NER component 345 is omitted from image generation apparatus 300.

According to some aspects, training component 350 identifies a training image, a text prompt, and layout information indicating a location of an element of the text prompt in the training image. In some examples, training component 350 computes a text feature map including a set of values corresponding to the element of the text prompt at a position corresponding to the location of the element. In some examples, training component 350 compares the predicted image to the training image. In some examples, training component 350 trains diffusion model 340 by updating parameters of diffusion model 340 based on the comparison.

In some examples, training component 350 compares the predicted layout information to the layout information (e.g., ground-truth layout information). In some examples, training component 350 updates parameters of preliminary diffusion model 330 based on the comparison of the predicted layout information to the layout information.

In some examples, training component 350 adds noise to the training image at a set of steps to obtain a set of intermediate noise images. In some examples, training component 350 computes a reconstruction loss by comparing the set of intermediate predicted images to the set of intermediate noise images, where the parameters of preliminary diffusion model 330 are updated based on the reconstruction loss.

According to some aspects, training component 350 is configured to compare the predicted image to a training image, and to update parameters of diffusion model 340 based on the comparison. According to some aspects, training component 350 is implemented as software stored in memory unit 310 and executable by processor unit 305, as firmware, as one or more hardware circuits, or as a combination thereof.

According to some aspects, training component 350 is omitted from image generation apparatus 300 and is included in a separate computing device. In some cases, image generation apparatus 300 communicates with training component 350 in the separate computing device to train diffusion model 340 and/or preliminary diffusion model 330 as described herein. According to some aspects, training component 350 is implemented as software stored in memory and executable by a processor of the separate computing device, as firmware in the separate computing device, as one or more hardware circuits of the separate computing device, or as a combination thereof.

According to some aspects, image generation apparatus 300 includes image encoder 355. According to some aspects, image encoder 355 comprises one or more ANNs configured to encode an image in a pixel space to image features in a latent space. According to some aspects, image encoder 355 is omitted from image generation apparatus 300.

According to some aspects, image generation apparatus 300 includes image decoder 360. According to some aspects, image decoder 360 comprises one or more ANNs configured to decode image features in a latent space to an image in a pixel space. According to some aspects, image decoder 360 is omitted from image generation apparatus 300.

FIG. 4 shows an example of a guided diffusion architecture 400 according to aspects of the present disclosure.

Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, as in pixel diffusion, or to image features generated by an encoder, as in latent diffusion.

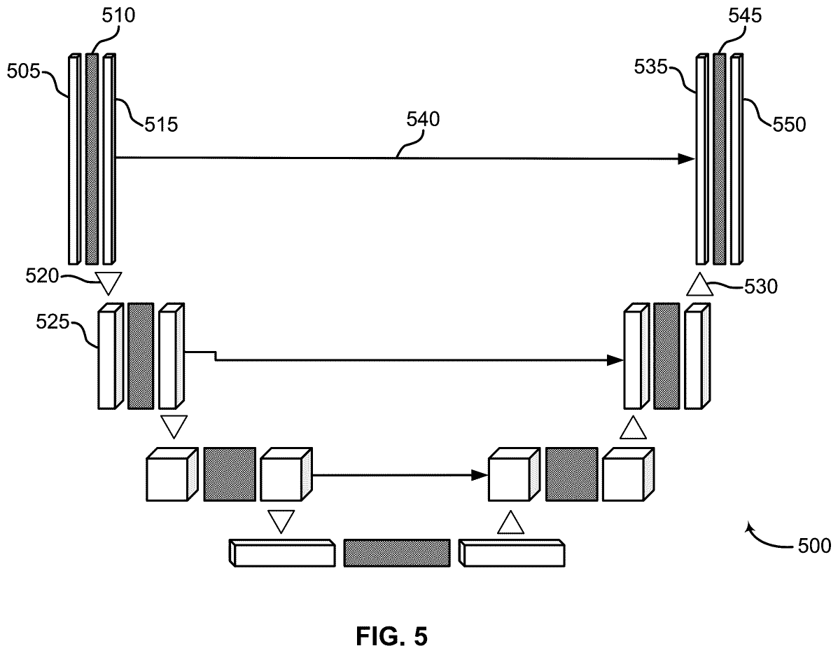

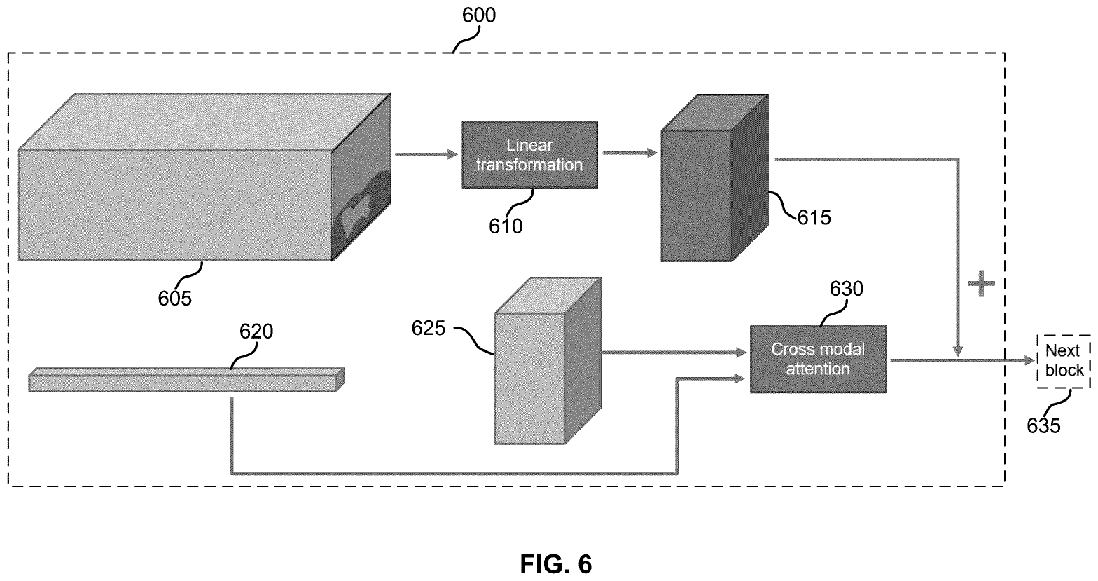

For example, according to some aspects, forward diffusion process 415 gradually adds noise to original image 405 in pixel space 410 to obtain noise images 420 at various noise levels. According to some aspects, reverse diffusion process 425 gradually removes the noise from noise images 420 at the various noise levels to obtain an output image 430. In some cases, reverse diffusion process 425 is implemented via a U-Net ANN (such as the U-Net architecture described with reference to FIGS. 5 and 6). In some cases, reverse diffusion process 425 is an example of, or includes aspects of, the diffusion model described with reference to FIG. 3. In some cases, reverse diffusion process 425 is an example of, or includes aspects of, the preliminary diffusion model described with reference to FIG. 3.

In some cases, an output image 430 is created from each of the various noise levels. According to some aspects, a training component described with reference to FIG. 3 compares the output image 430 to original image 405 to train reverse diffusion process 425.

Reverse diffusion process 425 can also be guided based on a guidance prompt such as text prompt 435, an image, a layout, a segmentation map, etc. Text prompt 435 can be encoded using text encoder 440 (e.g., a multi-modal encoder) to obtain guidance features 445 in guidance space 450. In some cases, text encoder 440 is an example of, or includes aspects of, the encoder described with reference to FIG. 3.

According to some aspects, guidance features 445 are combined with noise images 420 at one or more layers of reverse diffusion process 425 to ensure that output image 430 includes content described by text prompt 435. For example, guidance features 445 can be combined with noise images 420 using a cross-attention block within reverse diffusion process 425.

In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with their corresponding values.

As shown in FIG. 4, guided diffusion architecture 400 is implemented according to a pixel diffusion model. In some embodiments, guided diffusion architecture 400 is implemented according to a latent diffusion model. In a latent diffusion model, an image encoder (such as the image encoder described with reference to FIG. 3) first encodes original image 405 as image features in a latent space. Then, forward diffusion process 415 adds noise to the image features, rather than original image 405, to obtain noisy image features. Reverse diffusion process 425 gradually removes noise from the noisy image features (in some cases, guided by guidance features 445) to obtain denoised image features. An image decoder (such as the image decoder described with reference to FIG. 3) decodes the denoised image features to obtain output image 430 in pixel space 410. In some cases, as a size of image features in a latent space can be significantly smaller than a resolution of an image in a pixel space (e.g., 32, 64, etc. versus 256, 512, etc.), encoding original image 405 to obtain the image features can reduce inference time by a large amount.

FIG. 5 shows an example of a U-Net 500 according to aspects of the present disclosure. According to some aspects, a diffusion model (such as the diffusion model described with reference to FIG. 3 or the preliminary diffusion model described with reference to FIG. 3) is based on an ANN architecture known as a U-Net. According to some aspects, U-Net 500 receives input features 505, where input features 505 include an initial resolution and an initial number of channels, and processes input features 505 using an initial neural network layer 510 (e.g., a convolutional network layer) to produce intermediate features 515.

In some cases, intermediate features 515 are then down-sampled using a down-sampling layer 520 such that down-sampled features 525 have a resolution less than the initial resolution and a number of channels greater than the initial number of channels.

In some cases, this process is repeated multiple times, and then the process is reversed. That is, down-sampled features 525 are up-sampled using up-sampling process 530 to obtain up-sampled features 535. In some cases, up-sampled features 535 are combined with intermediate features 515 having a same resolution and number of channels via skip connection 540. In some cases, the combination of intermediate features 515 and up-sampled features 535 are processed using final neural network layer 545 to produce output features 550. In some cases, output features 550 have the same resolution as the initial resolution and the same number of channels as the initial number of channels.

According to some aspects, U-Net 500 receives additional input features to produce a conditionally generated output. In some cases, the additional input features include a vector representation of an input prompt. In some cases, the additional input features are combined with intermediate features 515 within U-Net 500 at one or more layers. For example, in some cases, a cross-attention module is used to combine the additional input features and intermediate features 515.

U-Net 500 is an example of, or includes aspects of, a U-Net included in the diffusion model described with reference to FIG. 3, the preliminary diffusion model described with reference to FIG. 3, or the segmentation component described with reference to FIG. 3. In some cases, U-Net 500 implements the reverse diffusion process as described with reference to FIG. 4.

FIG. 6 shows an example of a U-Net block 600 according to aspects of the present disclosure. The example shown includes U-Net block 600, text feature map 605, linear transformation process 610, transformed feature map 615, text prompt embedding 620, U-Net features 625, cross-modal attention block 630, and next U-Net block 635.

According to some aspects, U-Net block 600 is an iterative processing block included in a U-Net (such as the U-Net described with reference to FIG. 5). An iterative processing block refers to a sequence of processes that are performed on input data to produce an output, where the output is passed as input to a next iterative processing block.

For example, referring to FIG. 6, U-Net block 600 performs linear transformation process 610 on text feature map 605 to obtain transformed feature map 615, where transformed feature map 615 includes a number of features equal to a number of channels of the U-Net. In some cases, U-Net block 600 also uses cross-modal attention block 630 to combine text prompt embedding 620 with U-Net features 625 (e.g., intermediate features as described with reference to FIG. 5) to obtain preliminary combined features. In some cases, U-Net block 600 combines the preliminary combined features with transformed feature map 615 (for example, by adding the preliminary combined features to transformed feature map 615) to obtain combined features. In some cases, U-Net block 600 passes the combined features to next U-Net block 635, and the iterative process repeats.

### Multi-modal Image Generation

A method for multi-modal image generation is described with reference to FIGS. 7-13. One or more aspects of the method include obtaining a text prompt and layout information indicating a target location for an element of the text prompt; computing a text feature map including a plurality of values corresponding to the element of the text prompt at pixel locations corresponding to the target location; and generating an image based on the text feature map using a diffusion model, wherein the image includes the element of the text prompt at the target location. In some aspects, the text feature map comprises a multi-dimensional array including a first dimension corresponding to an image width, a second dimension corresponding to an image height, and a third dimension corresponding to an entity embedding.

Some examples of the method include generating a preliminary image based on the text prompt. Some examples further include segmenting the preliminary image to obtain a segmentation mask, wherein the layout information is based on the segmentation mask. Some examples of the method include displaying preliminary layout information based on the segmentation mask. Some examples further include receiving user input indicating the target location for the element of the text prompt in response to the displaying the preliminary layout information. In some aspects, the layout information comprises a label map or a segmentation mask, wherein the target location comprises a region of the label map or the segmentation mask.

Some examples of the method further include encoding the text prompt to obtain a text prompt embedding representing global information of the text prompt, wherein the image is generated based on the text prompt embedding. Some examples of the method further include identifying a plurality of entities in the text prompt including the element. Some examples further include encoding each of the plurality of entities to obtain a plurality of entity embeddings, wherein the text feature map comprises values from the plurality of entity embeddings at positions corresponding to the plurality of entities, respectively.

Some examples of the method further include identifying a noise image including random noise, wherein the image is generated based on the noise image. Some examples of the method further include generating intermediate features. Some examples further include combing the intermediate features with the text feature map to obtain combined features, wherein the image is generated based on the combined features.

Some examples of the method further include encoding the text prompt to obtain a text prompt embedding. Some examples further include combining the intermediate features with the text prompt embedding to obtain preliminary combined features, wherein the combined features are based on the preliminary combined features.

FIG. 7 shows an example of a method 700 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, the system generates an image based on a text prompt and layout information. In some cases, a user provides the text prompt to a user interface of the system. In some cases, the user provides the layout information via the user interface. In some cases, the system computes the layout information based on the text prompt. In some cases, the system generates the image using a diffusion model based on a text feature map, where the text feature map is computed based on the text prompt and the location information. By generating the image based on the text feature map, the diffusion model is able to obtain an image with an accurate positioning of elements depicted in the image using sparse layout information.

At operation 705, the system obtains a text prompt and layout information indicating a target location for an element of the text prompt. In some cases, the operations of this step refer to, or may be performed by, a feature generation component as described with reference to FIG. 3.

According to some aspects, a user provides the text prompt via a user interface (such as the user interface described with reference to FIG. 3) displayed on a user device by the image generation apparatus.

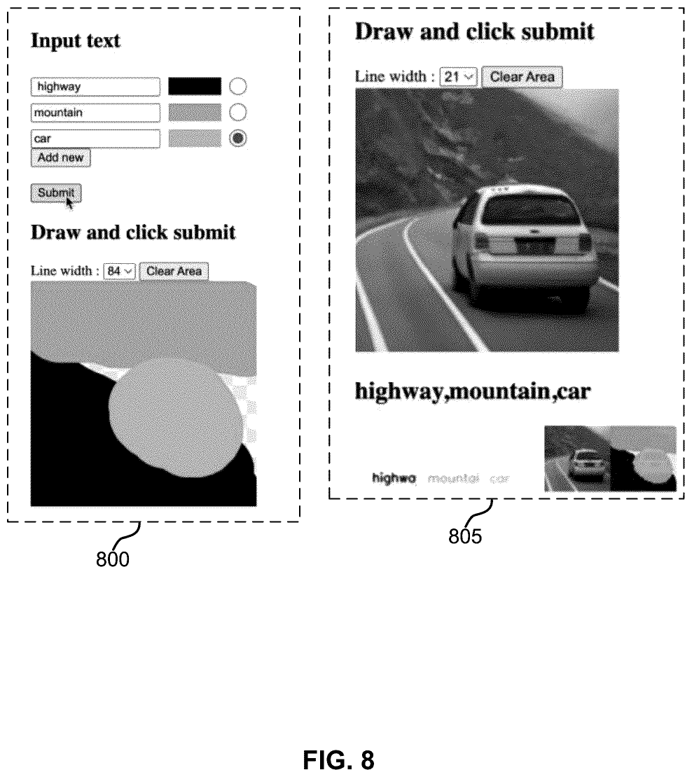

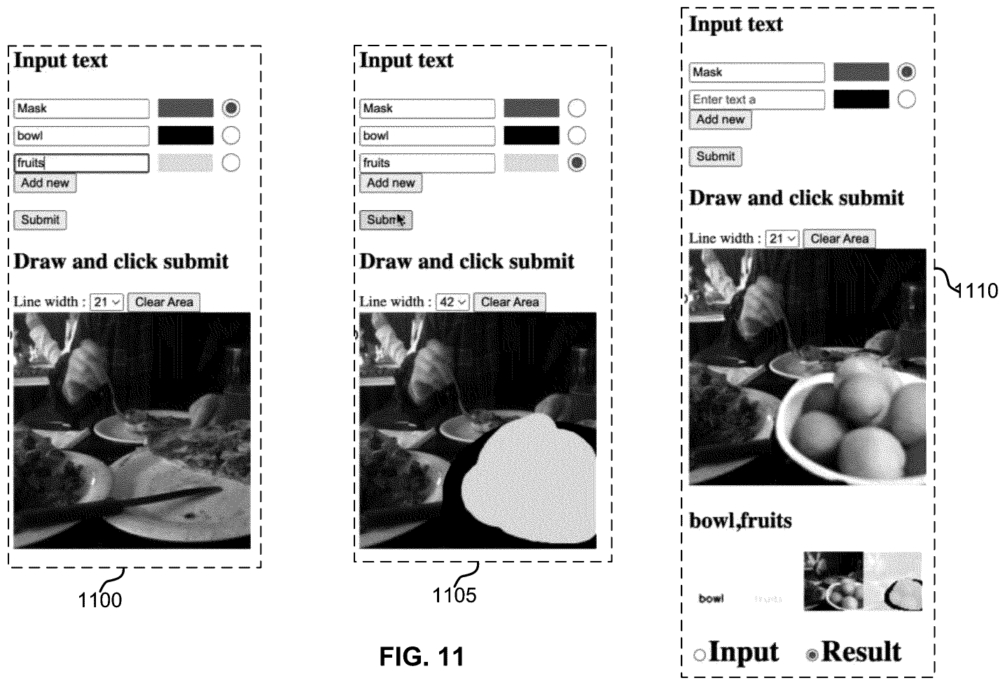

In some cases, the user provides a set of text prompts to the user interface, where each text prompt of the set of text prompts corresponds to an entity. For example, referring to FIG. 8, a user provides three text prompts corresponding to three elements to be included in an image (“highway”, “mountain”, and “car”) to the user interface. The user interface provides a button option to add more text prompts. Likewise, referring to FIG. 11, a user provides two text prompts corresponding to two elements to be added to an image (“bowl” and “fruits”).

In some cases, the user provides a single text prompt as a sentence to the user interface, and the user interface provides the sentence to a named entity recognition (NER) component as described with reference to FIG. 3 to identify and extract entities from the sentence. NER refers to a subtask of information extraction that seeks to locate and classify named entities mentioned in unstructured text into pre-defined categories such as person names, organizations, locations, medical codes, time expressions, quantities, monetary values, percentages, etc.

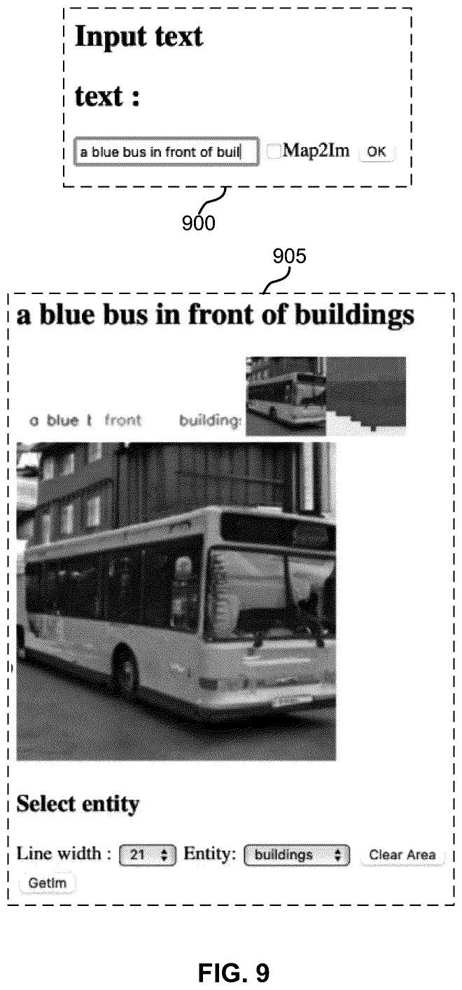

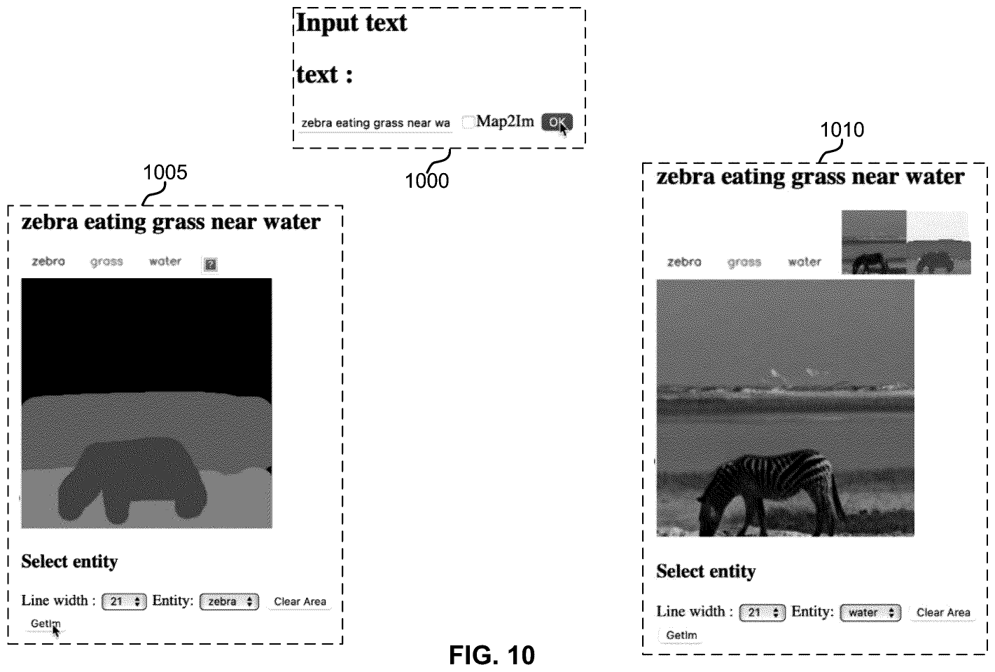

In some cases, the user interface displays each extracted named entity to the user (for example, via a drop-down menu), and the user can select an entity to be included in an image as an element. For example, referring to FIG. 9, a user provides a sentence “blue bus in front of buildings” to the user interface, the NER component extracts “blue bus” and “buildings” from the sentence as named entities, and the user interface displays “blue bus” and “buildings” as selectable elements in a drop-down menu. Likewise, referring to FIG. 10, a user provides a sentence “zebra eating grass near water” to the user interface, the NER component extracts “zebra”, “grass”, and “water” from the sentence as named entities, and the user interface displays “zebra”, “grass”, and “water” as selectable elements.

According to some aspects, the layout information comprises a label map, where the target location comprises a region of the label map.

In some cases, the user provides the label map via a brush tool input to the user interface. For example, referring to FIG. 8, a user selects an element displayed by the user interface (such as “car”) and paints an area of a blank canvas corresponding to a target location for a generated image that should include a car. In some cases, the user can select a line width for the brush tool input. The user can likewise provide target locations for one or more of the other displayed elements (“highway” and “mountain”). In some cases, each painted area is color-coded with the element to distinguish one painted area from another. The one or more painted areas are comprised in the label map, and the target locations comprise target pixels of the image to be generated. Likewise, referring to FIG. 10, after “zebra”, “grass”, and “water” are extracted as elements from an input sentence, the user can select one or more of the elements and provide a respective corresponding target location as layout information via a brush tool input.

The brush tool input can also be applied to a pre-existing image. For example, referring to FIG. 11, a user provides or the image generation apparatus generates an input image depicting a person eating food at a table. The user provides a brush tool input for one or more of the displayed elements (“bowl” and “fruits”) on the input image.

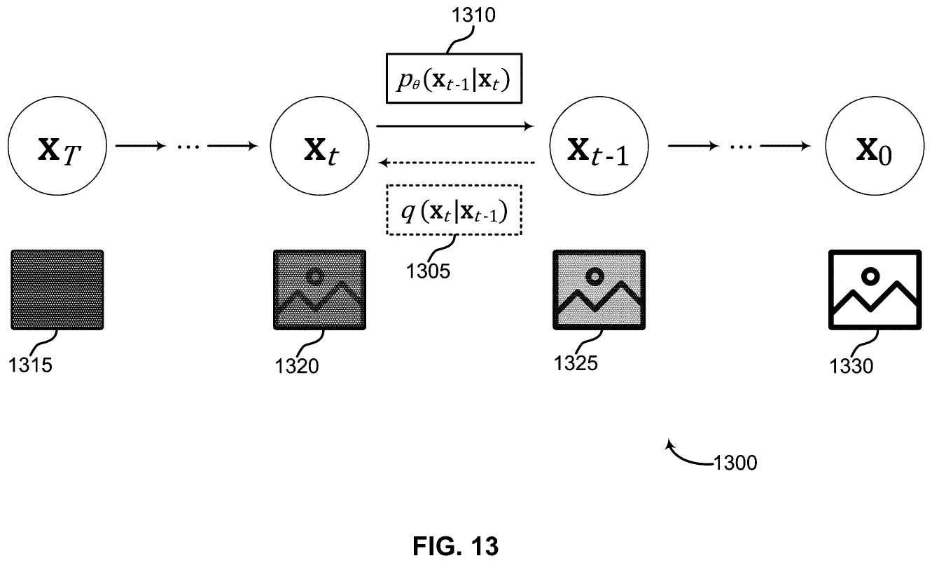

In some cases, the feature generation component obtains the label map via a preliminary diffusion model described with reference to FIG. 3. In some cases, an encoder as described with reference to FIG. 3 encodes the text prompt to obtain a preliminary text prompt embedding. The encoder provides the preliminary text prompt embedding to the preliminary diffusion model. The feature generation component generates a preliminary noise image and provides the preliminary noise image to the preliminary diffusion model. The preliminary diffusion model generates a preliminary image as the layout map by denoising the preliminary noise image based on the preliminary text prompt embedding using a reverse diffusion process described with reference to FIG. 13. In some cases, the preliminary image depicts elements corresponding to the preliminary text prompt embedding. According to some aspects, the label map comprises a cross-section of the preliminary image, where the label map comprises the layout information.

According to some aspects, the layout information comprises a segmentation mask, where the target location comprises a region of the segmentation mask. In some cases, the preliminary diffusion model provides the preliminary image to a segmentation component as described with reference to FIG. 3. The segmentation component segments the preliminary image to obtain a segmentation mask. In some cases, the layout information is based on the segmentation mask. For example, the segmentation mask identifies one or more masked areas respectively corresponding to locations of one or more elements depicted in the preliminary image. The one or more masked areas respectively indicate the target locations for the one or more elements.

In some cases, the user interface displays preliminary layout information based on the segmentation mask. For example, the preliminary layout information includes shaded pixels respectively corresponding to the target locations for the one or more elements. In some cases, the user interface receives user input indicating the target location for the element of the text prompt in response to displaying the preliminary layout information. For example, the user can provide an input via a layout brush tool of the user interface to rearrange the preliminary layout information, thereby rearranging the target location for the element of the text prompt.

According to some aspects, the user interface provides the text prompt to the feature generation component. According to some aspects, the user interface and/or the segmentation component provides the layout information to the feature generation component.

At operation 710, the system computes a text feature map including a set of values corresponding to the element of the text prompt at pixel locations corresponding to the target location. In some cases, the operations of this step refer to, or may be performed by, an image generation apparatus as described with reference to FIGS. 1 and 3.

According to some aspects, the text feature map comprises a multi-dimensional array including a first dimension corresponding to an image width, a second dimension corresponding to an image height, and a third dimension corresponding to an entity embedding. For example, in some cases, the text feature map comprises values from a set of entity embeddings at pixel locations corresponding to the set of entities, respectively. In some cases, for example, each pixel of the image to be generated corresponds to a vector representation (e.g., an entity embedding) of an entity, as represented in the text feature map. In some cases, for example, the image width and the image height correspond to the target locations for the elements respectively included in the layout information.

Several different processes can be used to obtain the text feature map. In a first example, the text feature map may be obtained by combining entity embedding vectors with layout information. In a second example, a preliminary diffusion model generates the text feature map directly based on the text prompt.

According to the first example, a text encoder encodes each of the set of entities to obtain a plurality of entity embeddings. Then, the feature generation component bundles the plurality of entity embeddings according to the layout information to obtain the text feature map. For example, each pixel of the image may be associated with an entity embedding vector based on the layout information to obtain a three-dimensional text feature map. In this example, neighboring pixels with the same semantic label can be associated with the same entity embedding vector.

According to the second example, the preliminary diffusion model computes the text feature map directly based on the plurality of entity embeddings and the label map or the layout information. For example, a global embedding of a text prompt can be input as guidance to a diffusion model that has been trained to output the three dimensional text feature map using a reverse diffusion process. In this example, neighboring pixels corresponding to a same element can have similar, but potentially slightly different, features in the third dimension corresponding to the entity embedding.

At operation 715, the system generates an image based on the text feature map using a diffusion model, where the image includes the element of the text prompt at the target location. In some cases, the operations of this step refer to, or may be performed by, a diffusion model as described with reference to FIG. 3.

In some cases, the user interface provides the text prompt to an encoder described with reference to FIG. 3. In some cases, the encoder encodes the text prompt to obtain a text prompt embedding representing global information of the text prompt. For example, in some cases, the text prompt embedding is a vector representation of a combination of individually provided text prompts, where each text prompt corresponds to a single element, or is a vector representation of a sentence, where each component of the sentence is included in the text prompt embedding.

In some cases, the text prompt embedding is encoded independently of whether or not a component of the text prompt has been selected by the user as an element. For example, a user may provide a sequence of text prompts “clear blue sky”, “sand beach”, “white dog running”, “cat”, and “pencil sketch”, or may provide an unstructured sentence “clear blue sky, sand beach, white dog running, cat, pencil sketch” as a text prompt, and may only select “clear blue sky”, “sand beach”, and “white dog running” as elements to be assigned location information. However, in some cases, the text prompt embedding includes a representation of the unselected components “cat” and “pencil sketch” so that information corresponding to “cat” and “pencil sketch” are represented in the image to be generated.

According to some aspects, the text prompt embedding comprises a sequence of text embedding tokens, where each text embedding token of the sequence of text embedding tokens respectively corresponds to a word included in the text prompt.

According to some aspects, the feature generation component provides the text feature map to the diffusion model. According to some aspects, the encoder provides the text prompt embedding to the diffusion model. According to some aspects, the feature generation component generates a random noise image including a random noise (for example, using a forward diffusion process as described with reference to FIG. 13) and provides the random noise image to the diffusion model. In some cases, the diffusion model generates the image based on the noise image and the text feature map (for example, using a reverse diffusion process described with reference to FIG. 13), where the image includes the element of the text prompt at the target location.

In some cases, the diffusion model uses the text prompt embedding as a guidance vector as described with reference to FIG. 4. For example, in some cases, a U-Net generates intermediate features (e.g., U-Net features) as described with reference to FIG. 6, and iteratively combines the intermediate features with the text prompt embedding using cross-modal attention to obtain combined preliminary features as described with reference to FIG. 6. In some cases, the diffusion model iteratively combines the text feature map or the transformed feature map described with reference to FIG. 6 with the preliminary combined features to obtain combined features as described with reference to FIG. 6. In some cases, the diffusion model denoises the noise image based on the combined features.

In some cases, the diffusion model is used to perform image inpainting. For example, in a case where the user has provided a brush input to provide layout information on an input image (such as the input image described with reference to FIG. 11), the painted areas corresponding to the layout image are interpreted by the diffusion model as masks, such that the diffusion model denoises the noise image to obtain the input image as a background and the elements corresponding to the painted areas as elements superimposed on the background.

By denoising the noise image based on the text feature map, the diffusion model is able to obtain an image with an accurate positioning of elements depicted in the image using sparse layout information, thereby reducing a processing speed of the system or an amount of user input to the user interface. By denoising the noise image based on the combined features, the diffusion model is able to obtain an image depicting multiple elements and a user-prescribed style included in a text prompt (e.g., “pencil-sketch”) without a user input to locate the element or the style, thereby reducing an amount of time that a user spends interacting with the user interface.

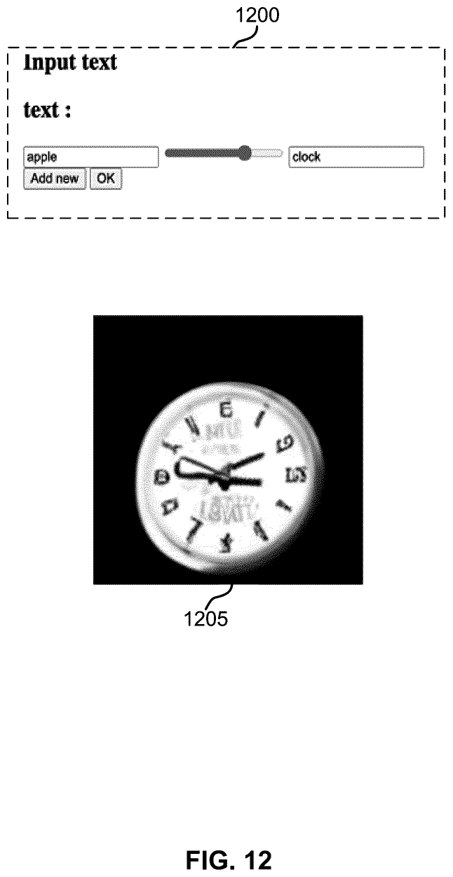

In some cases, the user interface provides an option to combine two or more elements as one element. For example, referring to FIG. 12, the user interface provides a slider to combine a selected element “apple” and a selected element “clock”, where moving the slider towards one element causes a resulting generated image to look more like the one element than the other element. For example, the user interface obtains weighting information based on the position of the slider, and provides the multiple elements and the weighting information to the language model. The language model generates a weighted embedding of the multiple elements based on the weighting information (for example, via max-pooling, averaging, addition, etc.) and computes the text feature map based on the weighted embedding.

FIG. 8 shows an example of semantic image synthesis according to aspects of the present disclosure. The example shown includes first user interface (UI) view 800 and second UI view 805. Referring to FIG. 8, first UI view 800 displays multiple text prompts provided by a user, a user selection of the text prompt “car”, color-coded layout information for the multiple text prompts provided by the user via a brush tool input on a blank canvas, and a user selection of a “submit” button that instructs the image generation apparatus described with reference to FIG. 3 to generate an image as described with reference to FIG. 7. Second UI view 805 displays the generated image, color-coded elements corresponding to the selected elements, and a representation of the layout information.

FIG. 9 shows an example of text-to-image generation using named entity recognition (NER) according to aspects of the present disclosure. The example shown includes first user interface (UI) view 900 and second UI view 905. Referring to FIG. 9 first UI view 900 displays a sentence “blue bus in front of buildings” provided by a user as a text prompt as well as an “OK” button to instruct the image generation apparatus described with reference to FIG. 3 to generate an image as described with reference to FIG. 7. Second UI view 905 displays the generated image as well as preliminary layout information as described with reference to FIG. 7, where the user can provide an input to rearrange the preliminary layout information to change a position of the elements in the generated image, extracted from the text prompt via a NER component described with reference to FIG. 3 and identified by the user via a drop-down menu, as described with reference to FIG. 7.

FIG. 10 shows an example of user-guided text-to-image generation using named entity recognition (NER) according to aspects of the present disclosure. The example shown includes first UI view 1000, second UI view 1005, and third UI view 1010. Referring to FIG. 10, first UI view 1000 displays a sentence “zebra eating grass near water” provided by a user as a text prompt as well as an “OK” button to instruct the image generation apparatus described with reference to FIG. 3 to generate an image as described with reference to FIG. 7. Second UI view 1005 displays a drop-down menu for selecting entities extracted from the text prompt by an NER component as described with reference to FIG. 7, color-coded layout information for the multiple entities provided by the user via a brush tool input on a blank canvas, and a user selection of a “Getim” button that instructs the image generation apparatus described with reference to FIG. 3 to generate an image as described with reference to FIG. 7. Third UI view 1010 displays a generated image and a representation of the layout information.

FIG. 11 shows an example of multi-modal image editing according to aspects of the present disclosure. The example shown includes first user interface (UI) view 1100, second UI view 1105, and third UI view 1110. First UI view 1100 displays an input image provided by a user or generated by the image generation apparatus as described with reference to FIG. 7. First UI view 1100 also displays a “Mask” selection button indicating that the image generation apparatus is operating in an image editing mode. First UI view also displays multiple text prompts (“bowl” and “fruits”) provided by the user. In some cases, a user can also provide a single text prompt from which entities are extracted using an NER component as described with reference to FIG. 7.

Second UI view 1105 displays color-coded layout information for the multiple entities provided by the user via a brush tool input on the input image, and a user selection of a “Submit” button that instructs the image generation apparatus described with reference to FIG. 3 to generate an image as described with reference to FIG. 7. Third UI view 1110 displays the generated image that includes the input image as background and the selected elements superimposed on the background. Third UI view 1110 also displays a representation of the layout information.

FIG. 12 shows an example of image generation using a hybrid brush according to aspects of the present disclosure. The example shown includes user interface (UI) view 1200 and image 1205. Referring to FIG. 12, UI view 1200 displays two elements (“apple” and “clock”) either directly input by a user as text prompts to the user interface or that have been extracted from a text prompt using an NER component as described with reference to FIG. 7. UI view 1200 also displays a hybrid brush (e.g., a slider) that allows a user to indicate that the two elements are to be combined as one element, as well as a degree to which the combined element should look like one of the two elements. Image 1205 is an example of an image that is generated by the image generation apparatus based on a weighted embedding of the combined elements.

FIG. 13 shows an example of diffusion processes 1300 according to aspects of the present disclosure. The example shown includes forward diffusion process 1305 and reverse diffusion process 1310. In some cases, forward diffusion process 1305 generates a noise image in a pixel space (or noisy features in a latent space). In some cases, reverse diffusion process 1310 denoises the noise image (or noisy features in the latent space) to obtain image 1330 (or image features in the latent space).

According to some aspects, forward diffusion process 1305 iteratively adds Gaussian noise to an input at each diffusion step t according to a known variance schedule 0<β₁<β₂<···<βB_{T}<1:

q(xₜ|xₜ₋₁)= [symbol] (xₜ;\sqrt{1−βₜxₜ₋₁,βₜI}) (1)

According to some aspects, the Gaussian noise is drawn from a Gaussian distribution with mean μₜ=\sqrt{1−βₜxₜ₋₁} and variance σ²=βₜ≥1 by sampling Σ˜ [symbol] (0, I) and setting xₜ=\sqrt{1βₜxₜ₋₁}+\sqrt{βₜΣ}. Accordingly, beginning with an initial input x₀, forward diffusion process 1305 produces x₁, . . . , xₜ···x_{T}, where x_{T} is pure Gaussian noise.

For example, in some cases, a feature generation component or a training component described with reference to FIG. 3 maps an observed variable x₀ (such as the text feature map, the combined features, or the preliminary text prompt embedding described with reference to FIG. 7) in either a pixel space or a latent space to intermediate variables x₁, . . . , x_{T} using a Markov chain, where the intermediate variables x₁, . . . , x_{T} have a same dimensionality as the observed variable x₀. In some cases, the Markov chain gradually adds Gaussian noise to the observed variable x₀ or to the intermediate variables x₁, . . . , x_{T}, respectively, as the variables are passed through the ANN to obtain an approximate posterior q(x_{1:T}|x₀).

According to some aspects, during reverse diffusion process 1310, a diffusion model such as the diffusion model or the preliminary diffusion model described with reference to FIG. 3 gradually removes noise from x_{T} to obtain a prediction of the observed variable x₀ (e.g., a representation of what the diffusion model thinks the image 1330 should be). A conditional distribution p(xₜ₋₁| xₜ) of the observed variable x₀ is unknown to the diffusion model, however, as calculating the conditional distribution would require a knowledge of a distribution of all possible images. Accordingly, the diffusion model is trained to approximate (e.g., learn) a conditional probability distribution p_{θ}(xₜ₋₁| xₜ) of the conditional distribution p(xₜ₋₁| xₜ):

pθ(xₜ₋₁|xₜ)= [symbol] (xₜ₋₁;μθ(xₜ,t),Σ_{θ}(xₜ,t)) (2)

In some cases, a mean of the conditional probability distribution p_{θ}(xₜ₋₁| xₜ) is parameterized by ye and a variance of the conditional probability distribution p_{θ}(xₜ₋₁| xₜ) is parameterized by Σ_{θ}. In some cases, the mean and the variance are conditioned on a noise level t (e.g., an amount of noise corresponding to a diffusion step t). According to some aspects, the diffusion model is trained to learn the mean and/or the variance.

According to some aspects, the diffusion model initiates reverse diffusion process 1310 with noisy data x_{T} (such as noise image 1315). According to some aspects, the diffusion model iteratively denoises the noisy data x_{T} to obtain the conditional probability distribution p_{θ}(xₜ₋₁| xₜ). For example, in some cases, at each step t−1 of reverse diffusion process 1310, the diffusion model takes xₜ (such as first intermediate image 1320) and t as input, where t represents a step in a sequence of transitions associated with different noise levels, and iteratively outputs a prediction of xₜ₋₁ (such as second intermediate image 1325) until the noisy data x_{T} is reverted to a prediction of the observed variable x₀ (e.g., image 1330, which can respectively represent the image or the preliminary image described with reference to FIG. 7).

According to some aspects, a joint probability of a sequence of samples in the Markov chain is determined as a product of conditionals and a marginal probability:

x_{T}: p_{θ}(x_{0:T}):=p(x_{T})Πₜ₌₁^{T}p_{θ}(xₜ₋₁|xₜ) (3)

In some cases, p(x_{T})= [symbol] (x_{T}; 0, I) is a pure noise distribution, as reverse diffusion process 1310 takes an outcome of forward diffusion process 1305 (e.g., a sample of pure noise x_{T}) as input, and Πₜ₌₁^{T} p_{θ}(xₜ₋₁| xₜ) represents a sequence of Gaussian transitions corresponding to a sequence of addition of Gaussian noise to a sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noise images, and \tilde{x} represents the generated image with high image quality.

### Training

A method for multi-modal image generation is described with reference to FIGS. 14-16. One or more aspects of the method include identifying a training image, a text prompt, and layout information indicating a location of an element of the text prompt in the training image; computing a text feature map including a plurality of values corresponding to the element of the text prompt at a position corresponding to the location of the element; generating a predicted image based on the text feature map using a diffusion model; comparing the predicted image to the training image; and training the diffusion model by updating parameters of the diffusion model based on the comparison.

Some examples of the method further include generating predicted layout information using a preliminary diffusion model. Some examples further include comparing the predicted layout information to the layout information. Some examples further include updating parameters of the preliminary diffusion model based on the comparison of the predicted layout information to the layout information.

Some examples of the method further include adding noise to the training image at a plurality of steps to obtain a plurality of intermediate noise images. Some examples further include generating a plurality of intermediate predicted images corresponding to the plurality of intermediate noise images. Some examples further include computing a reconstruction loss by comparing the plurality of intermediate predicted images to the plurality of intermediate noise images, wherein the parameters of the diffusion model are updated based on the reconstruction loss.

FIG. 14 shows an example of a method 1400 for updating parameters of a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 14, the system updates parameters of a diffusion model to generate an image as described with reference to FIG. 7.

At operation 1405, the system identifies a training image, a text prompt, and layout information indicating a location of an element of the text prompt in the training image. In some cases, the operations of this step refer to, or may be performed by, a training component as described with reference to FIG. 3. For example, in some cases, the training component retrieves the training image, the text prompt, and the layout information from a database (such as a database described with reference to FIG. 1).

In some cases, the training component provides the training image and text description to a text-based object detection model to extract a bounding box of an element included in the text prompt and in the image. In some cases, the training component provides the image and the bounding box to a segmentation component described with reference to FIG. 3. In some cases, the segmentation component computes a segmentation mask for the element based on the image and the bounding box, where the layout information comprises the segmentation mask.

At operation 1410, the system computes a text feature map including a set of values corresponding to the element of the text prompt at a position corresponding to the location of the element. In some cases, the operations of this step refer to, or may be performed by, a training component as described with reference to FIG. 3. For example, in some cases, the training component provides the training image, the text prompt, and the layout information to a feature generation component and the feature generation component computes the text feature map based on the text prompt and the layout information as described with reference to FIG. 7. The feature generation component provides the text feature map to the training component.

At operation 1415, the system generates a predicted image based on the text feature map using a diffusion model. In some cases, the operations of this step refer to, or may be performed by, a diffusion model as described with reference to FIG. 3. For example, in some cases, the diffusion model generates the predicted image as described with reference to FIG. 16.

At operation 1420, the system compares the predicted image to the training image. In some cases, the operations of this step refer to, or may be performed by, a training component as described with reference to FIG. 3. For example, in some cases, the training component computes a reconstruction loss by comparing the set of intermediate predicted images described with reference to FIG. 16 to the set of intermediate noise images described with reference to FIG. 16. According to some aspects, the system compares the predicted image at each stage n−1 described with reference to FIG. 16 to an actual image (or image features), such as the image at stage n−1 or the original training image. For example, given observed data x, the training component trains the diffusion model to minimize a variational upper bound of a negative log-likelihood—log p_{θ}(x) of the training data.

The term “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

At operation 1425, the system trains the diffusion model by updating parameters of the diffusion model based on the comparison. In some cases, the operations of this step refer to, or may be performed by, a training component as described with reference to FIG. 3. For example, in some cases, the training component updates parameters of the diffusion model using gradient descent. In some cases, the training component trains the diffusion model to learn time-dependent parameters of the Gaussian transitions.

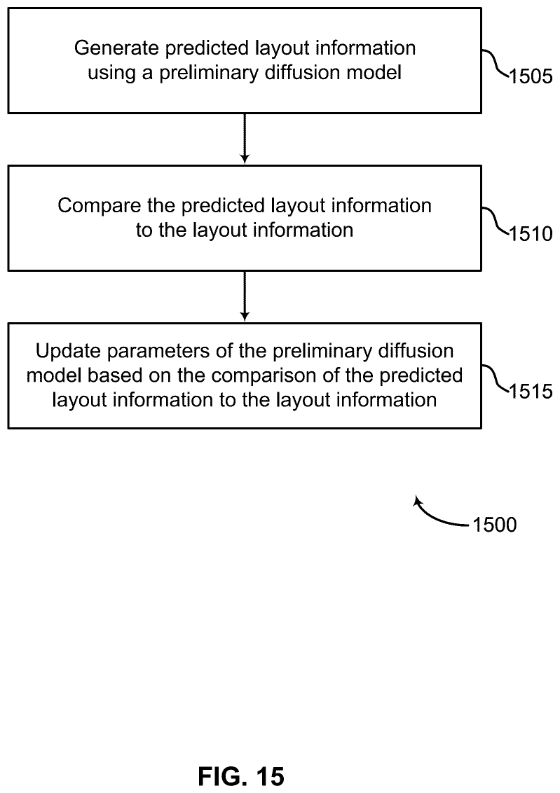

FIG. 15 shows an example of a method 1500 for training a preliminary diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 15, the system trains a preliminary diffusion model to generate layout information as described with reference to FIG. 7.

At operation 1505, the system generates predicted layout information using a preliminary diffusion model. In some cases, the operations of this step refer to, or may be performed by, a preliminary diffusion model as described with reference to FIG. 3. For example, in some cases, the training component provides the text prompt to the preliminary diffusion model, and the preliminary diffusion model computes layout information as described with reference to FIG. 7, where the layout information is the predicted layout information.

At operation 1510, the system compares the predicted layout information to the layout information. In some cases, the operations of this step refer to, or may be performed by, a training component as described with reference to FIG. 3. For example, according to some aspects, the system compares the predicted layout information to the layout information according to a layout information loss function, such as a regression loss function.

At operation 1515, the system updates parameters of the preliminary diffusion model based on the comparison of the predicted layout information to the layout information. In some cases, the operations of this step refer to, or may be performed by, a training component as described with reference to FIG. 3.

FIG. 16 shows an example of a method 1600 for training a diffusion model according to aspects of the present disclosure. Referring to FIG. 16, the system pretrains an untrained diffusion model to implement the pretrained diffusion model as the diffusion model used in the training process described with reference to FIG. 12.

At operation 1605, the system initializes a diffusion model. In some cases, the operations of this step refer to, or may be performed by, a training component as described with reference to FIG. 3. In some cases, the initialization includes defining the architecture of the diffusion model and establishing initial values for parameters of the diffusion model. In some cases, the training component initializes the untrained diffusion model to implement a U-Net architecture described with reference to FIG. 6. In some cases, the initialization includes defining hyper-parameters of the architecture of the untrained diffusion model, such as a number of layers, a resolution and channels of each layer block, a location of skip connections, and the like.

At operation 1610, the system adds noise to a training image using a forward diffusion process in N stages. In some cases, the operations of this step refer to, or may be performed by, a training component as described with reference to FIG. 4. For example, in some cases, the training component adds noise to the training image at a set of steps to obtain a set of intermediate noise images. In some cases, the training component adds noise to the training image using a forward diffusion process as described with reference to FIG. 13.

At operation 1615, at each stage n, starting with stage N, the system predicts an image for stage n−1 using a reverse diffusion process. In some cases, the operations of this step refer to, or may be performed by, a diffusion model described with reference to FIG. 3. For example, in some cases, the diffusion model generates a set of intermediate predicted images corresponding to the set of noise images. According to some aspects, the diffusion model performs a reverse diffusion process based on the text feature map as described with reference to FIG. 13, where each stage n corresponds to a diffusion step t, to predict noise that was added by the forward diffusion process. In some cases, at each stage, the diffusion model predicts noise that can be removed from an intermediate image to obtain the predicted image. In some cases, an image is predicted at each stage of the training process.

FIG. 17 shows an example of a computing device 1700 for multi-modal image generation according to aspects of the present disclosure. In one aspect, computing device 1700 includes processor(s) 1705, memory subsystem 1710, communication interface 1715, I/O interface 1720, user interface component(s) 1725, and channel 1730.

In some embodiments, computing device 1700 is an example of, or includes aspects of, the image generation apparatus as described with reference to FIGS. 1 and 3. In some embodiments, computing device 1700 includes one or more processors 1705 that can execute instructions stored in memory subsystem 1710 to obtain a text prompt and layout information indicating a target location for an element of the text prompt; compute a text feature map including a plurality of values corresponding to the element of the text prompt at pixel locations corresponding to the target location; and generate an image based on the text feature map using a diffusion model, wherein the image includes the element of the text prompt at the target location.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote control device interfaced with a user interface directly or through the I/O controller), or a combination thereof. In some cases, user interface component(s) 1725 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt and layout information indicating a target location for an element of the text prompt, wherein the target location is within an image to be generated;
computing a text feature map including a plurality of values corresponding to the element of the text prompt at pixel locations corresponding to the target location; and
generating the image based on the text feature map using a diffusion model, wherein the image includes the element of the text prompt at the target location.

2. The method of claim 1, further comprising:
generating a preliminary image based on the text prompt; and
segmenting the preliminary image to obtain a segmentation mask, wherein the layout information is based on the segmentation mask.

3. The method of claim 2, further comprising:
displaying preliminary layout information based on the segmentation mask; and
receiving user input indicating the target location for the element of the text prompt in response to the displaying the preliminary layout information.

4. The method of claim 1, further comprising:
encoding the text prompt to obtain a text prompt embedding representing global information of the text prompt, wherein the image is generated based on the text prompt embedding.

5. The method of claim 1, wherein:
the layout information comprises a label map or a segmentation mask, wherein the target location comprises a region of the label map or the segmentation mask.

6. The method of claim 1, further comprising:
identifying a plurality of entities in the text prompt including the element; and
encoding each of the plurality of entities to obtain a plurality of entity embeddings, wherein the text feature map comprises values from the plurality of entity embeddings at positions corresponding to the plurality of entities, respectively.

7. The method of claim 1, wherein:
the text feature map comprises a multi-dimensional array including a first dimension corresponding to an image width, a second dimension corresponding to an image height, and a third dimension corresponding to an entity embedding.

8. The method of claim 1, further comprising:
identifying a noise image including random noise, wherein the image is generated based on the noise image.

9. The method of claim 1, further comprising:
generating intermediate features; and
combining the intermediate features with the text feature map to obtain combined features, wherein the image is generated based on the combined features.

10. The method of claim 9, further comprising:
encoding the text prompt to obtain a text prompt embedding; and
combining the intermediate features with the text prompt embedding to obtain preliminary combined features, wherein the combined features are based on the preliminary combined features.

11. A method comprising:
initializing a diffusion model;
obtaining training data including a training image, a text prompt, and layout information indicating a location of an element of the text prompt in the training image;
computing a text feature map including a plurality of values corresponding to the element of the text prompt at a position corresponding to the location of the element; and
training the diffusion model to generate images corresponding to the text prompt and the layout information based on the text feature map and the training data.

12. The method of claim 11, wherein the training further comprises:
computing a predicted image based on the text feature map using the diffusion model;
computing a loss function by comparing the predicted image to the training image; and
updating the diffusion model is based on the loss function.

13. The method of claim 11, further comprising:
generating predicted layout information using a preliminary diffusion model;
comparing the predicted layout information to the layout information; and
updating parameters of the preliminary diffusion model based on the comparison of the predicted layout information to the layout information.

14. The method of claim 11, further comprising:
adding noise to the training image at a plurality of steps to obtain a plurality of intermediate noise images;
generating a plurality of intermediate predicted images corresponding to the plurality of intermediate noise images; and
computing a reconstruction loss by comparing the plurality of intermediate predicted images to the plurality of intermediate noise images, wherein the parameters of the diffusion model are updated based on the reconstruction loss.

15. An apparatus comprising:
one or more processors;
one or more memory components coupled with the one or more processors;
a first diffusion model configured to generate a text feature map including a plurality of values corresponding to an element of a text prompt at a position corresponding to a target location; and
a second diffusion model configured to generate a predicted image based on the text feature map, wherein the predicted image includes the element of the text prompt at the target location.

16. The apparatus of claim 15, further comprising:
a named entity recognition (NER) component configured to identify a plurality of entities in the text prompt including the element.

17. The apparatus of claim 15, further comprising:
an encoder configured to encode the text prompt to obtain a text prompt embedding representing global information of the text prompt.

18. The apparatus of claim 15, further comprising:
a user interface configured to identify the text prompt and layout information indicating the target location for the element of the text prompt.

19. The apparatus of claim 15, wherein:
the second diffusion model comprises a pixel diffusion model.

20. The apparatus of claim 15, wherein:
the first diffusion model or the second diffusion model comprises a U-net architecture.
